(19) United States
(12) Patent Application Publication
(10) Pub. No.: US 2008/0097725 A1
(43) Pub. Date: Apr. 24, 2008

(54) MONITORING SYSTEM AND METHOD

(75) Inventors: Chad Eric Knodle, Greer, SC (US); Matthew Allen Nelson, Gardnerville, NV (US); Stephen Robert Schmid, Minden, NV (US); Marc Steven Tompkins, Minden, NV (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/552,009

(22) Filed: Oct. 23, 2006

(51) Int. Cl. G06F 19/00; G06F 17/40

(52) U.S. Cl. 702/188; 340/870.01; 702/1; 702/127; 702/182; 702/186; 702/187; 702/189; 340/500; 340/540; 340/679

(57) ABSTRACT

Disclosed is a monitoring system implementing a network. The system includes at least one source of dynamic data, the at least one source configured to be in signal communication with a machine, a monitoring module configured for communication with the at least one source, configured for receiving the dynamic data, and configured for converting the dynamic data to output data for transmittal over the network, a controller configured for communication with the monitoring module and the network, and configured for receiving the output data, a computing resource configured for communication with the network, and configured for receiving the output data, and a rule implementer in the monitoring module, the rule implementer configured to implement at least one system rule.

### FIELD OF THE INVENTION

The disclosure relates generally to a system for monitoring mechanical systems.

### BACKGROUND OF THE INVENTION

In the field of industrial equipment monitoring, monitoring components may generate various signals representative of dynamic conditions. The signal-generating components are typically sensors and transducers positioned on or otherwise closely associated with points of interest of the machine systems. The signals are used to analyze the performance of the machine system. Machine systems thus instrumented may include rotary machines, assembly lines, production equipment, material handling equipment, power generation equipment, as well as many other types of machines of varying complexity.

A variety of unwanted conditions may develop in machine systems that can occur rapidly, or develop over time or in certain situations, such as loading or due to wear or system degradation. Where unwanted conditions appear, various types of response may be warranted. For example, the response of the monitoring components to different dynamic conditions may differ greatly depending upon the machine system itself, its typical operating characteristics, the nature of the system, and the relative importance of the conditions that may develop. Such responses may range from taking no action, to reporting, to logging, to providing alerts, and to energizing or de-energizing parts or all of the machine system.

In order to make such responses, operating information must be analyzed. However, operating information from the sensors is not typically useful in its raw form, and must be processed, analyzed, and considered in conjunction with other factors, such as operating speeds, to determine the appropriate response to existing or developing conditions.

Responses to monitored signals and processed data may differ due to a number of factors. Again, these may include the normal operating characteristics of the machine system. Also, during certain operating periods, such as during startup or a change in speed or loading, the various ranges may be of greater or lesser interest in deciding upon an appropriate response.

Existing monitoring and protection systems do not provide a desired degree of efficiency, and can require too large a network bandwidth, particularly with regard to currently increasing network traffic. There is a desire, therefore, for a more efficient approach to monitoring systems with a more reasonable bandwidth requirement.

### BRIEF DESCRIPTION OF THE INVENTION

Disclosed is a monitoring system implementing a network. The system includes at least one source of dynamic data, the at least one source configured to be in signal communication with a machine, a monitoring module configured for communication with the at least one source, configured for receiving the dynamic data, and configured for converting the dynamic data to output data for transmittal over the network, a controller configured for communication with the monitoring module and the network, and configured for receiving the output data, a computing resource configured for communication with the network, and configured for receiving the output data, and a rule implementer in the monitoring module, the rule implementer configured to implement at least one system rule.

Also disclosed is a monitoring method implementing a network. The method includes creating at least one system rule for monitoring at least one condition in a machine, sensing machine conditions of the machine and transmitting a dynamic data stream representative thereof, converting at least a portion of the dynamic data stream to output data, transmitting at least a portion of the output data to a controller, determining at least one condition of the machine via the output data transmitted to the controller, transmitting at least a portion of the output data from the controller to a computer resource, and analyzing at least a portion of the output data via the computing resource, wherein the analyzed output data provides information relating to a health characteristic of the machine.

Further disclosed is a monitoring system implementing a network. The system includes at least one source of dynamic data, the source configured to be in signal communication with a machine, a monitoring module configured for communication with the at least one source, configured for receiving the dynamic data, and configured for converting the dynamic data to output data for transmittal over the network, a controller being in direct communication with the monitoring module to receive the output data directly form the monitoring module, the controller also being in communication with the network, a computing resource configured for communication with the network, and configured for receiving the output data, and a rule implementer in the monitoring module, the rule implementer configured to receive at least one system rule directly from the controller, and implement the at least one system rule.

### BRIEF DESCRIPTION OF THE DRAWINGS

The following descriptions should not be considered limiting in any way. With reference to the accompanying drawings, like elements are numbered alike:

FIG. 1 is a schematic illustration of a monitoring system in accordance with an embodiment of the invention; and

FIG. 2 is a block diagram illustrating a monitoring method in accordance with an embodiment of the invention.

### DETAILED DESCRIPTION OF THE INVENTION

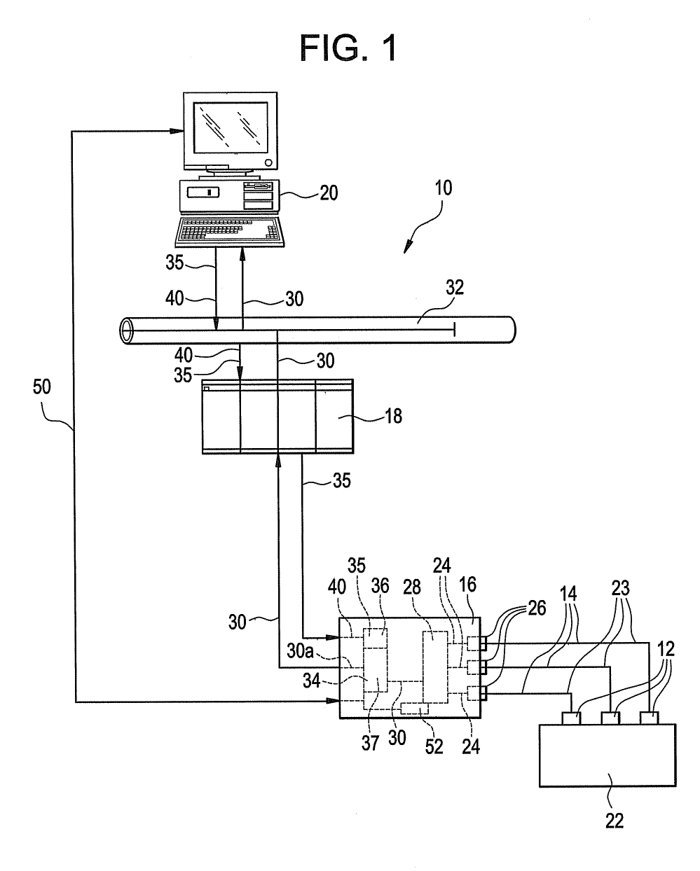

Referring to FIG. 1, a monitoring system 10 is illustrated. The system 10 includes at least one source 12 of dynamic data 14 (in the form of an analog signal 23, as described below), a monitoring module 16, a controller 18, and computing resource 20. The components of the system 10 allow for a two-way transmission of data, which will be discussed hereinbelow, beginning with acquisition of the dynamic data 14 from the at least one source 12.

The at least one source 12 of the dynamic data 14 may be a plurality of sensing systems, such as sensors or transducers that are associated with any type of machine 22, such as rotary machines, assembly lines, production equipment, material handling equipment, and power generation equipment. The acquired dynamic data 14 may pertain to conditions of the machine 22, such as pressure, temperature, or vibration. When acquired by the sources 12 (sensing systems), the dynamic data 14 is in raw, analog form, containing large quantities of information.

After sensing and acquiring the dynamic data 14 in analog form, each sensing system 12 transmits the analog signal 23 (briefly mentioned above) containing dynamic data 14 to the monitoring module 16. These sensing systems 12 are configured to be in signal communication with the monitoring module 16, via, for example, electrical, electromagnetic, or fiber-optical connection. The monitoring module 16 receives the dynamic data 14 via each analog signal 23, and converts it into digital data 24 via analog/digital (A/D) converters 26 associated with the monitoring module 16. In an embodiment, the conversion to digital data 24 is provided by A/D software disposed within the monitoring module 16.

The monitoring module 16 may also include a field programmable gate array 28 for first level processing of the data from the A/D converters 26. The field programmable gate array (FPGA) 28 is a semiconductor device containing programmable logic components and programmable interconnects. The programmable logic components can be programmed to duplicate the functionality of basic logic gates. These logic gates are computer circuits with several inputs but only one output, allowing each gate, and therefore the FPGA 28 as a whole, to act as a data filter for condensing large quantities of information contained in a data stream, such as the digital data 24 of the system 10. In this manner, digital data 24 is converted to output data 30 via the FPGA 28, with the output data 30 having a more desirable bandwidth (smaller bandwidth due to a condensing and filtering of the information) for transmission over a network 32. It should be noted that, as the name implies, the FPGA 28 is “field programmable,” and thus, can be programmed after a manufacturing process by a customer/designer so that the FPGA 28 can perform whatever logic function is desired.

The monitoring module 16 may further include an additional processor 34 (additional to the FPGA 28) that provides data compression and implementation of system rules 35. Data compression, which may be implemented via software 37 installed in the monitoring module 16 (particularly in the additional processor 34), is a process of encoding information using fewer bits (or other information-bearing units) than an unencoded representation would use through use of specific encoding schemes. Data compression algorithms usually exploit statistical redundancy in such a way as to represent data more concisely, but completely. Data compression in the system 10 may further compress the output data 30 from the FPGA 28 into data compressed output data (which will be referred to hereinafter and in the Figure as output data 30), further reducing output data bandwidth for transmission over the network 32.

As mentioned above, the additional processor 34 also implements the system rules 35 of the system 10. These rules 35 determine what dynamic data 14 from each source 12 is important, with importance being determined relative to different condition (temperature, vibration, pressure, etc.) thresholds within the machine 22 (or different machines) during different operating periods of the machine 22, such as startup, a change in machine speed, or loading. The system rules 35 are implemented by at least one rule implementer 36 such as change detection filters and threshold detectors based on operating conditions of the machine 22. These rules 35 determine what output data 30 is important enough to be transmitted from the monitoring module 16 to the controller 18 for eventual machine diagnostics in the controller 18 or computing resource 20, based on the output data 30 transmitted.

The controller 18 is configured to be in signal communication with the monitoring module 16, via electrical, electromagnetic, or fiber-optical connection, for example, and may be any known control system, such as a programmable logic controller (PLC) or a distributed control system (DCS). The controller 18 uses the condensed, rule-filtered output data 30 to determine operating conditions of the machine 22, and make decisions pertaining to adjustment to the machine 22. Along with making these determinations, the controller 18 transmits the output data 30 to the computing resource 20 via the network 32, to which the controller 18 is communicated via electrical, electromagnetic, or fiber-optical connection.

The computing resource 20 is also in communication with the network 32 via electrical, electromagnetic, or fiber-optical connection. The computing resource 20, which may be any type of server or computer, is located remotely of the controller 18, monitoring module 16, data sources 12, and machine 22. Data can be both received by the computing resource 20 from the controller 18, and transmitted from the computing resource 20 to the controller 18. For example, the system rules 35 may be initially transmitted from the computing resource 20 to the controller 18 via the network 32. The controller 20 further applies the rules 35 to operating parameters of the machine 22, and transmits rules 35 to the rule implementer 36 of the monitoring module 16 for implementation. The initial set of system rules 35 created by the computing resource 20 may be implemented until output data 30 reaches the computing resource 20 (via the system 10 components), is analyzed by the computing resource 20, and demonstrates that a change to the system rules 35 would be desirable. When change is desirable, the computing resource 20 will send a change signal 40 to the controller 18, which will instruct the monitoring module 16 to change parameter(s) of the system rules 35. This change in the system rules can be desirable due to age of the machine 22 or its components, demand on the machine 22, and change in machine environment.

Referring to connection 50 of FIG. 1, it should be appreciated that a transportable computing system 20, such as a laptop, may be transported to the site of the monitoring module 16 (becoming non-remote), and be directly connected with the monitoring module 16. The computing resource 20 may upload system rules 35 or adjustments to system rules 35 directly to the monitoring module via this direct connection 50. In addition, in an exemplary embodiment, the monitoring module may include memory storage software 52 that stores output data 30 (as selected by the system rules 35 currently implemented), which may be accessed by a user of the computing resource 20 (which may be any computing option) via the direct connection 50.

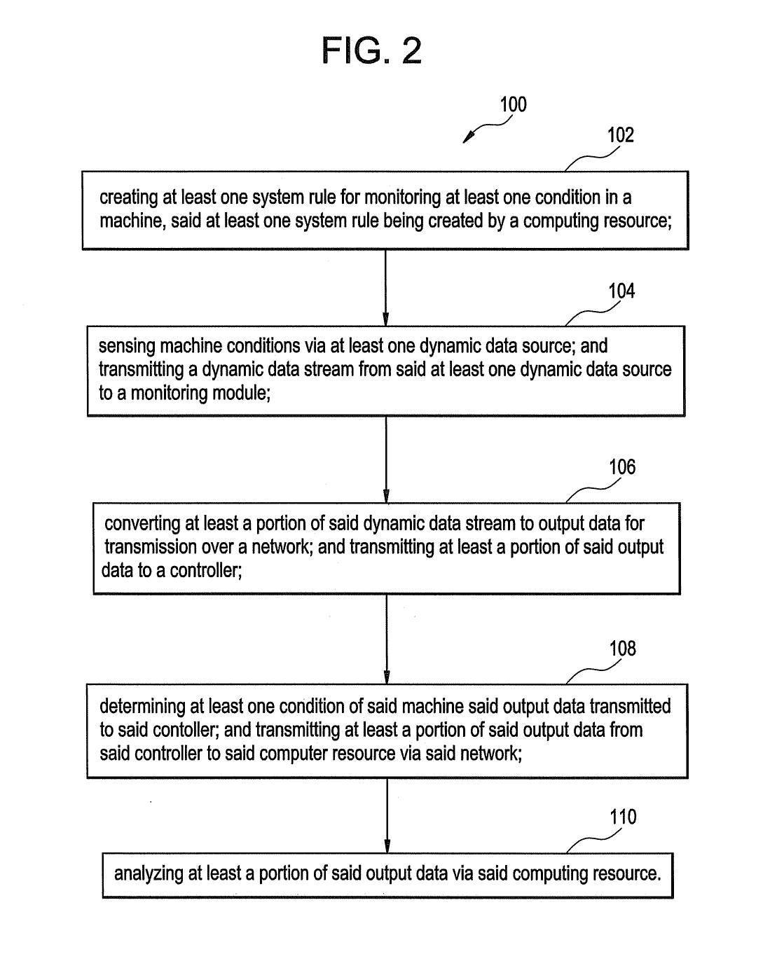

Referring to FIG. 2, a monitoring method 100 is illustrated and includes creating at least one system rule 35 for monitoring at least one condition in a machine 22, as shown in operational block 102, the at least one system rule 35 being created by a computing resource 20. The method 100 also includes sensing machine conditions of the machine via at least one dynamic data source 12, and transmitting a dynamic data stream 14 representative thereof from the at least one dynamic data source 12 to a monitoring module 16, as shown in operational block 104. The method 100 further includes converting at least a portion of the dynamic data stream 14 to output data 30, for eventual transmission over a network 32, and transmitting at least a portion of the output data 30 to a controller 18, as shown in operational block 106. The method 100 additionally includes determining at least one condition of the machine 22 via the output data 30 transmitted to the controller 18, and transmitting at least a portion of the output data 30 transmitted from the controller 18 to the computer resource 20 via the network 32, as shown in operational block 108. The method 100 also includes analyzing at least a portion of the output data 30 with the computing resource 20, wherein the analyzed output data 30 provides information relating to a health characteristic of the machine 22, as shown in operational block 110.

While the embodiments of the disclosed method and apparatus have been described with reference to exemplary embodiments, it will be understood by those skilled in the art that various changes may be made and equivalents may be substituted for elements thereof without departing from the scope of the embodiments of the disclosed method and apparatus. In addition, many modifications may be made to adapt a particular situation or material to the teachings of the embodiments of the disclosed method and apparatus without departing from the essential scope thereof. Therefore, it is intended that the embodiments of the disclosed method and apparatus not be limited to the particular embodiments disclosed as the best mode contemplated for carrying out the embodiments of the disclosed method and apparatus, but that the embodiments of the disclosed method and apparatus will include all embodiments falling within the scope of the appended claims.

What is claimed is:

1. A monitoring system implementing a network, the system comprising:
at least one source of dynamic data, said at least one source configured to be in signal communication with a machine;
a monitoring module configured for communication with said at least one source, configured for receiving said dynamic data, and configured for converting said dynamic data to output data for transmittal over the network;
a controller configured for communication with said monitoring module and the network, and configured for receiving said output data;
a computing resource configured for communication with the network, and configured for receiving said output data; and
a rule implementer in said monitoring module, said rule implementer configured to implement at least one system rule.

2. The system according to claim 1, wherein said at least one system rule is configured to determine whether said output data converted from said dynamic data from each of said at least one sources will be transmitted to said controller for transmittal over said network.

3. The system according to claim 1, wherein said controller is configured to determine at least one condition of said machine based on said output data received from said monitoring module.

4. The system according to claim 1, wherein said output data is configured to be analyzable by said computing resource, and said system rules are configured to be modifiable based on analyzation of said output data.

5. The system according to claim 1, wherein said at least one source of dynamic data comprises a plurality of sensing systems positioned to sense machine conditions within said machine, each of said plurality of sensing systems configured for transmitting an analog signal of said dynamic data to said monitoring module.

6. The system according to claim 1, wherein said monitoring module is configured to include an analog/digital converter channel for said dynamic data transmitted from each of said at least one source, said analog/digital converter channels configured for converting said dynamic to digital data.

7. The system according to claim 6, wherein said monitoring module includes a field programmable gate array configured for converting said digital data to said output data.

8. The system according to claim 1, wherein said monitoring module includes dynamic data storage capabilities, with said system rules configured to determine what dynamic data should be stored.

9. The system according to claim 1, wherein said computing resource is disposed remotely to said at least one source, said monitoring module, and said controller.

10. The system according to claim 1, wherein said computing resource is configured to directly connect to said monitoring system.

11. The system according to claim 1, wherein said computing resource creates and modifies said at least one system rule.

12. A monitoring method implementing a network, the method comprising:
creating at least one system rule for monitoring at least one condition in a machine;
sensing machine conditions of said machine and transmitting a dynamic data stream representative thereof;
converting at least a portion of said dynamic data stream to output data;
transmitting at least a portion of said output data to a controller;
determining at least one condition of said machine via said output data transmitted to said controller;
transmitting at least a portion of said output data from said controller to a computer resource; and
analyzing at least a portion of said output data via said computing resource,
wherein said analyzed output data provides information relating to a health characteristic of said machine.

13. The method according to claim 12, further comprising:
modifying said at least one system rule based on said analyzing.

14. The method according to claim 12, wherein said creating occurs in said computing network.

15. The method according to claim 12, wherein said transmitting of said at least a portion of said output data from said controller to said computer resource occurs via the network.

16. A monitoring system implementing a network, the system comprising:
at least one source of dynamic data, said source configured to be in signal communication with a machine;
a monitoring module configured for communication with said at least one source, configured for receiving said dynamic data, and configured for converting said dynamic data to output data for transmittal over the network;
a controller being in direct communication with said monitoring module to receive said output data directly form said monitoring module, said controller also being in communication with the network;
a computing resource configured for communication with the network, and configured for receiving said output data; and
a rule implementer in said monitoring module, said rule implementer configured to receive at least one system rule directly from said controller, and implement said at least one system rule.

17. A system according to claim 16, wherein said at least one system rule determines whether at least a portion of said output data should be transmitted to at least one of said controller and said computer resource for machine diagnostics based on said at least a portion of said output data.

18. A system according to claim 16, wherein said at least one system rule determines whether at least a portion of said output data should be stored in memory storage software disposed in said monitoring module to be accessed by said computer resource for machine diagnostics based on said at least a portion of said output data.
